(19) United States
(12) Patent Application Publication
(10) Pub. No.: US 2022/0187893 A1
(43) Pub. Date: Jun. 16, 2022

(54) DYNAMIC ENERGY PERFORMANCE PREFERENCE BASED ON WORKLOADS USING AN ADAPTIVE ALGORITHM

(71) Applicant: INTEL CORPORATION, Santa Clara, CA (US)

(72) Inventors: Premanand SAKARDA, Acton, MA (US); Efraim ROTEM, Haifa (IL); Eliezer WEISSMANN, Haifa (IL); Hisham ABU SALAH, Majdal Shams (IL); Hadas BEJA, Yahud (IL); Russell FENGER, Beaverton, OR (US); Deepak GANAPATHY, Folsom, CA (US); James HERMERDING, II, Vancouver, WA (US); Ido KARAVANY, Givot Bar (IL); Nivedha KRISHNAKUMAR, Bangalore (IN); Sudheer NAIR, Portland, OR (US); Gilad OLSWANG, Kfar Menahem (IL); Moran PERI, Kiryat Mtotzkin (IL); Avishai WAGNER, Kfar Sabe (IL); Zhongsheng WANG, Portland, OR (US); Noha YASSIN, Arraba (IL)

(21) Appl. No.: 17/442,374

(22) PCT Filed: Jul. 14, 2020
(86) PCT No.: PCT/US2020/042014

§ 371 Date: Sep. 23, 2021

Related U.S. Application Data
(60) Provisional application No. 62/874,411, filed on Jul. 15, 2019.

(51) Int. Cl. G06F 1/324; G06F 1/3296

(52) U.S. Cl. CPC G06F 1/324; G06F 1/3296

(57) ABSTRACT

Described are mechanisms and methods for tracking user behavior profile over large time intervals and extracting observations for a user usage profile. The mechanisms and methods use machine learning (ML) algorithms embedded into a dynamic platform and thermal framework (DPTF) (e.g., Dynamic Tuning Technology) and predict device workloads using hardware (HW) counters. These mechanisms and methods may accordingly increase performance and user responsiveness by dynamically changing an Energy Performance Preference (EPP) based on a longer time workload analysis and workload prediction.

### CLAIM OF PRIORITY

This application claims priority of U.S. Provisional Application No. 62/874,411 titled “Dynamic Energy Performance Preference Based On Workloads Using An Adaptive Algorithm,” filed Jul. 15, 2019, which is incorporated by reference in its entirety.

### BACKGROUND

Designs may prioritize performance at the cost of power consumption and energy consumption. Some products may implement a power/performance preference input and/or a set of underlying optimization algorithms. Such features may facilitate the detection of workload behavior and adaptation of P-states to this behavior. For example, a transition from a deep C-state to being 100% active may be assumed to be an interactive action that drives full turbo.

However, such “reverse engineering” of usage profiles may be limited in success and may have many false positives (e.g., redundant turbo transitions) which may cause wasted energy, and/or false negatives (e.g., missed performance needs) which may result in low performance and/or user experience.

### BRIEF DESCRIPTION OF THE DRAWINGS

The embodiments of the disclosure will be understood more fully from the detailed description given below and from the accompanying drawings of various embodiments of the disclosure. However, while the drawings are to aid in explanation and understanding, they are only an aid, and should not be taken to limit the disclosure to the specific embodiments depicted therein.

FIG. 1 illustrates a pCode firmware interface to an operating system and software, in accordance with some embodiments of the disclosure.

FIG. 2 illustrates interfaces across multiple modules for dynamic Energy Performance Preference (EPP), in accordance with some embodiments of the disclosure.

FIG. 3 illustrates an architecture using dynamic EPP, in accordance with some embodiments of the disclosure.

FIG. 4 illustrates a set of plots showing workload classes classified by a machine-learning engine, in accordance with some embodiments.

FIG. 5 illustrates a flowchart for workload classification, in accordance with some embodiments.

FIG. 6 illustrates a plot showing performance gains using dynamic EPP when system is powered by direct current (DC), in accordance with some embodiments of the disclosure.

FIG. 7 illustrates a computer system or computing device with mechanisms for dynamic EPP, in accordance with some embodiments.

### DETAILED DESCRIPTION

Fixed balancing policies for energy and performance of a processor may account merely for short-term micro-architectural behavior, but may not account for user usage profiles. Such fixed balancing solutions may be sub-optimal, because they may produce many false positives and false negatives (e.g., the power/performance algorithm may launch a full turbo feature or mode when there is little to no user perceived value, which may waste energy, and/or may keep running at a low-P state, which may in turn result in low benchmark scores and/or less positive user experience. Here, P-states refer to power performance states such as those defined by the Advanced Configuration and Power Interface (ACPI) specification, version 6.3 released January 2019. P-states provide a mechanism to scale the frequency and/or voltage at which the processor runs so as to reduce the power consumption of the processor and to use optimal energy. Conversely, C-states (such as those defined by the ACPI specification) are stated when the processor has reduced or turned off selected functions. Various embodiments herein are applicable to any power or energy performance metric and are not limited to a particular P-state or C-state, and/or those defined by the ACPI specification.

Various embodiments provide mechanisms and methods for tracking user behavior profile over large time intervals (e.g., seconds, minutes, hours, days, weeks, months) and extracting observations for a user usage profile. A human activity may be characterized by from seconds to minutes of consistency (e.g. web browsing or video playback, opening certain applications, etc.). The embodiments of the mechanisms and methods disclosed herein also use machine-learning (ML) algorithms embedded into a dynamic platform and thermal framework (DPTF) such as Intel's Dynamic Tuning Technology (DTT) and predict device workloads using hardware (HW) performance monitoring counters. DPTF/DTT provides mechanisms for platform components and devices to be exposed to individual technologies in a consistent and modular fashion. DPTF/DTT enables a coordinated control of the platform to achieve the power and thermal management goals.

These mechanisms and methods may accordingly increase performance and user responsiveness by dynamically changing an Energy Performance Preference (EPP) value based on profiling the workload for a longer duration and predicting the type of workload. The mechanisms and methods may be used while a device is on battery power, but may also have significance when used for power-limited systems on alternating current (AC) such as power from a wall plug.

Some mechanisms and methods incorporate hierarchical control with higher hierarchy performing usage analysis (e.g., over time intervals of seconds to minutes, in a machine-learning SW (software) driver), as well as underlying power management unit (PCU) and pCode control. Here, pCode refers to a firmware executed by the PCU to manage performance of the processor. For example, pCode may set frequencies and appropriate voltages for the processor. Part of the pCode are accessible via an operating system (OS). In various embodiments, the mechanisms and methods may dynamically change an EPP value based on workloads, user behavior, and/or system conditions. There may be a well-defined interface between an operating system and the pCode. The interface may allow or facilitate the software configuration of several parameters and/or may provide hints to the pCode. As an example, an EPP parameter may inform the pCode algorithm as to whether performance or battery life is more important.

In some embodiments, an algorithm in a driver (such as an adaptive mini-filter driver, mailbox driver, DTT driver, etc.) may use an interface from a filter manager of the operating system to detect certain types of events, such as file opening events, file creation events, file closing events, and application opening events for productivity usage, and may then dynamically change the value of EPP for higher performance for that duration of the event. In addition, a machine-learning algorithm embedded into the DTT (or separate from the DTT) may predict a device workload using HW counters, and pCode may dynamically change the value for EPP for higher performance and/or increased battery life. An EPP value may be used by a pCode algorithm to set processor core frequencies, internal system-on-chip (SoC) interconnect fabric frequencies, and/or turbo durations. As the EPP value is reduced, the system may become adaptive, and may provide higher performance, which may be desirable to a user for higher quality of service.

There are many technical effects of the various embodiments. For example, the mechanisms and methods disclosed herein may yield 10% to 20% performance improvements in responsiveness for application-launch and file-opening operations. Accordingly, they may advantageously increase system performance. The disclosed mechanisms and methods may facilitate better characterization of user behavior, and better fitting of a power/performance configuration to user needs and perceived experience, which may permit original equipment manufacturers (OEMs) to advantageously provide an additional 10% to 20% system performance. Other technical effects will be evident from the various figures and embodiments.

In the following description, numerous details are discussed to provide a more thorough explanation of embodiments of the present disclosure. It will be apparent to one skilled in the art, however, that embodiments of the present disclosure may be practiced without these specific details. In other instances, well-known structures and devices are shown in block diagram form, rather than in detail, in order to avoid obscuring embodiments of the present disclosure.

Note that in the corresponding drawings of the embodiments, signals are represented with lines. Some lines may be thicker, to indicate a greater number of constituent signal paths, and/or have arrows at one or more ends, to indicate a direction of information flow. Such indications are not intended to be limiting. Rather, the lines are used in connection with one or more exemplary embodiments to facilitate easier understanding of a circuit or a logical unit. Any represented signal, as dictated by design needs or preferences, may actually comprise one or more signals that may travel in either direction and may be implemented with any suitable type of signal scheme.

Throughout the specification, and in the claims, the term “connected” means a direct electrical, mechanical, or magnetic connection between the things that are connected, without any intermediary devices. The term “coupled” means either a direct electrical, mechanical, or magnetic connection between the things that are connected or an indirect connection through one or more passive or active intermediary devices. The term “circuit” or “module” may refer to one or more passive and/or active components that are arranged to cooperate with one another to provide a desired function. The term “signal” may refer to at least one current signal, voltage signal, magnetic signal, or data/clock signal. The meaning of “a,” “an,” and “the” include plural references. The meaning of “in” includes “in” and “on.”

The terms “substantially,” “close,” “approximately,” “near,” and “about” generally refer to being within +/−10% of a target value. Unless otherwise specified the use of the ordinal adjectives “first,” “second,” and “third,” etc., to describe a common object, merely indicate that different instances of like objects are being referred to, and are not intended to imply that the objects so described must be in a given sequence, either temporally, spatially, in ranking, or in any other manner.

It is to be understood that the terms so used are interchangeable under appropriate circumstances such that the embodiments of the invention described herein are, for example, capable of operation in other orientations than those illustrated or otherwise described herein.

The terms “left,” “right,” “front,” “back,” “top,” “bottom,” “over,” “under,” and the like in the description and in the claims, if any, are used for descriptive purposes and not necessarily for describing permanent relative positions.

For purposes of the embodiments, the transistors in various circuits, modules, and logic blocks are Tunneling FETs (TFETs). Some transistors of various embodiments may comprise metal oxide semiconductor (MOS) transistors, which include drain, source, gate, and bulk terminals. The transistors may also include Tri-Gate and FinFET transistors, Gate All Around Cylindrical Transistors, Square Wire, or Rectangular Ribbon Transistors or other devices implementing transistor functionality like carbon nanotubes or spintronic devices. MOSFET symmetrical source and drain terminals i.e., are identical terminals and are interchangeably used here. A TFET device, on the other hand, has asymmetric Source and Drain terminals. Those skilled in the art will appreciate that other transistors, for example, Bi-polar junction transistors-BJT PNP/NPN, BiCMOS, CMOS, etc., may be used for some transistors without departing from the scope of the disclosure.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

In addition, the various elements of combinatorial logic and sequential logic discussed in the present disclosure may pertain both to physical structures (such as AND gates, OR gates, or XOR gates), or to synthesized or otherwise optimized collections of devices implementing the logical structures that are Boolean equivalents of the logic under discussion.

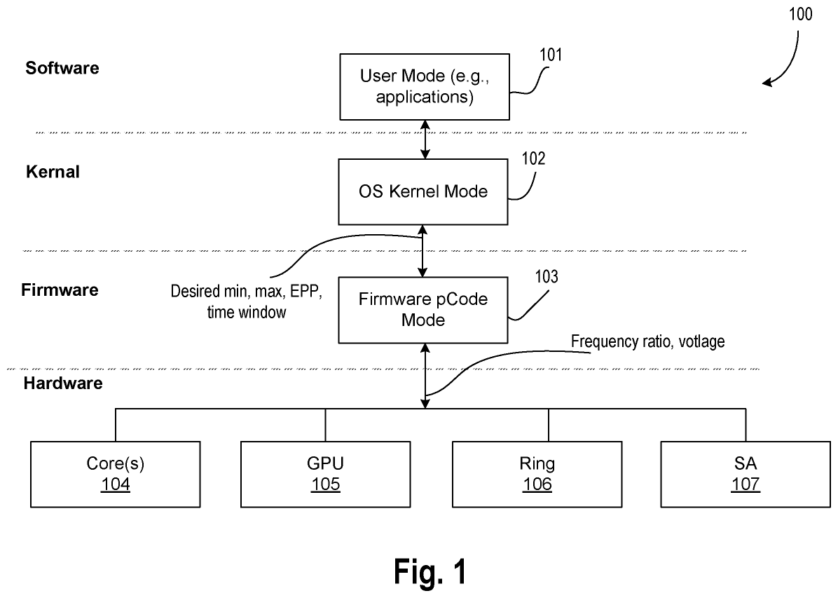

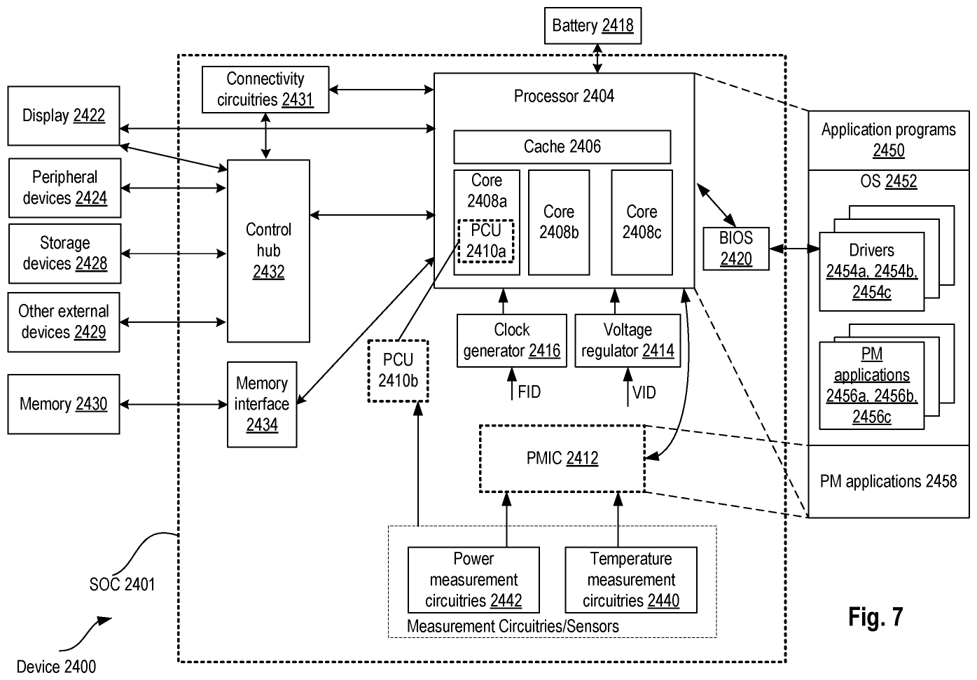

FIG. 1 illustrates a hardware to software hierarchy 100 with pCode interface to an operating system and software, in accordance with some embodiments of the disclosure. Hierarchy 100 has four levels of abstractions including software having applications that allow for user mode 101 operations, kernel with operating system mode 102 operations, firmware with pCode mode 103 operations, and hardware with components such as processor core(s) 104, graphics processor unit (GPU) 105, mesh or ring interconnect fabric 106, and system agent (SA) 107. In some embodiments, the various components are standalone components with their own packages. In some embodiments, the one or more components are part of a system-on-chip coupled in single package. In some embodiments, some of the one or more components may be in an SoC while other components may be outside of the SoC. In some embodiments, any one of the components may include a power control unit (PCU) or any appropriate power management logic that executes the pCode (firmware). In some embodiments, the PCU is a separate hardware component. In some embodiments, the PCU executes the firmware separately from the one or more components that are managed for power performance by the PCU. In cases where the PCU is part of the one or more hardware components, the PCU executes the pCode firmware and managements power performance of the one or more hardware components. Various configurations are for hierarchy 100 are also illustrated with reference to FIG. 7.

Referring back to FIG. 1, user mode 101 includes software applications (e.g., web-browser, email handler, word processing software, etc.) that communicate with the operating system via well-established application programming interfaces (APIs). Here, operating system mode 102 includes I/O manager, filter manager, file system driver, storage driver, etc., that communicate between applications in user mode 101 with firmware 103 and/or hardware. The operating system receives a default value for EPP, which may be a value between a maximum and minimum allowable value of the EPP, from the pCode. pCode may also provide a time window to the operating system as to when to apply the EPP value. Traditionally, the EPP value is fixed for a particular energy or performance preference for the processor. This value can traditionally be changed by the operating system statically upon reboot, for example, but not dynamically after reboot based on workload and user behavior.

Traditionally, EPP values are static values with default values. The default values for Microsoft Windows® operating system are shown in Table 1.

TABLE 1

| Operating system power | | |
|---|---|---|
| policy | AC EPP | DC EPP |
| Best performance | 25 | 33 |
| Better performance | 33 | 50 |
| Better battery | 33 | 70 |
| Battery saver | — | 70 |

An operating system owns the EPP settings to the system-on-chip (SoC) hardware P-state (HWP) algorithm. Windows operating system maps EPP based on operating system processor power management (PPM) settings and operating system slider position. EPP value typically defines the performance versus energy tradeoffs within HWP. HWP EPP changes the sustained and maximum frequencies used by the SoC. Currently, the EPP values are static. These parameters or values can be changed by the operating system statically (e.g., at boot time, or transition of AC to DC or DC to AC power source). For example, an original equipment manufacturer (OEM) may statically configure EPP values using the slider position, and thus change the EPP values for AC and DC conditions.

pCode may use various parameters to set appropriate frequencies for a core frequency, a GPU frequency, and an internal SOC frequency, based on parameters that may be configured by software. Using the mechanisms and methods disclosed herein, a driver (e.g., a mini-filter driver) may identify when to change an EPP value based on workload and/or usage. In some embodiments, mechanisms and methods disclosed herein monitor at least three factors over time under various workloads and operating conditions. These three factors include energy consumed by the processor, sustained performance of the processor, and burst performance (e.g., responsiveness) of the processor. The mechanisms and methods of various embodiments may adaptively or dynamically change a value of EPP to improve or optimize one or more of the at least three factors. Here, changing a value dynamically generally refers to change in a parameter in real-time while the processor is running (e.g., after boot operation) without requirement a reboot or restart of the processor. Table 2 provides some hardware P-state interfaces between hardware components (e.g., core(s) 104, GPU 105, mesh or ring fabric 106, SA 107, etc.) and the operating system via the pCode. These interfaces are well-defined between the operating system and the pCode.

TABLE 2

| Parameters | Description | Default |
|---|---|---|
| Minimum | Minimum performance to | IA32_HWP_Copabilities |
| Performance | achieve the required quality | lowest performance |
| | of service (QoS) | |
| Maximum | Maximum performance that | IA32_HWP_Copabilities |
| Performance | is expected by the hardware | highest performance |
| Desired Performance | Explicit performance hint to | 0, hardware autonomous |
| | the hardware | selection |
| Energy performance | Performance preference | 0x80, uses as a hint to the |
| preference (EPP) | from 0 to energy efficiency | hardware |
| | preference of 0xFFh | |
| Activity Window | Time value from profile 1 μ | 0, hardware determines |
| | to 1270 seconds | appropriate time window |

As discussed herein, the pCode is a firmware in Intel system-on-chip (SoC) that sets the frequencies and appropriate voltages for the SOC. The interface allows the software to configure several parameters and provide hints to the pCode. As an example, the Energy Performance Preference (EPP) parameter informs the pCode algorithm whether performance is more important or battery life. pCode uses these parameters to set appropriate frequencies for the Core, GPU and internal SoC frequencies based on the parameters (See Table 2) that are configured by the software.

Various embodiments provide mechanism and method to adjust one or more of these parameters adaptively. For example, the EPP value can be modified adaptively according to workload conditions. These mechanism and methods can be implemented as part of the DTT driver and/or other modules in the OS kernel mode 102. In some embodiments, dynamic adjustment to EPP is achieved using machine-learning (ML) algorithm to improve performance, responsiveness while maintaining battery life in DC mode.

For example, a DTT driver (interfacing modules of the OS and the pCode) receives prediction from a machine-learning engine executing in the hardware to classify and predict user behavior and provide a prediction value corresponding to the user behavior. The prediction value corresponds to an EPP value, which is then modified dynamically by the OS. In some embodiments, DTT software sends workload hint to system-on-chip (SoC) via a pCode interface. The SoC opportunistically scales internal p-state control algorithm (HWP) for each type of workload hint. In various embodiments, runtime workload hint to the SoC is defined as one of: idle, battery life, bursty, sustained, and/or semi-active. The machine-learning engine creates workload classification prediction (e.g., one of idle, battery life, bursty, sustained, and/or semi-active) for a given workload. The workload hint has a corresponding prediction value. Based on the prediction value, in some embodiments, the OS then instructs the pCode (firmware) to perform EPP control. For example, pCode adjusts the frequency and/or voltage for one or more of the hardware components (e.g., core(s) 104, GPU 105, mesh or ring fabric 106, SA 107, etc.) according to the new EPP value.

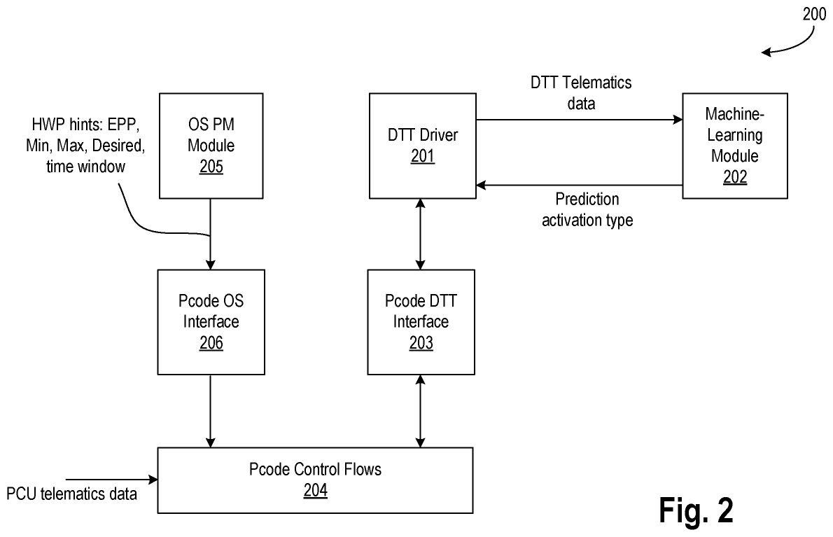

FIG. 2 illustrates a functional diagram 200 with interfaces across multiple modules for dynamic Energy Performance Preference (EPP), in accordance with some embodiments of the disclosure. Functional diagram 200 provides modules in the kernel and firmware. In some embodiments, DTT driver 201 includes logic (e.g., software module) to interface with a machine-learning (ML) module or engine 202. In some embodiments, machine-learning engine 202 is implemented in software in the user mode. In some embodiments, machine-learning engine 202 is implemented in hardware using multipliers and summers. In some embodiments, machine-learning engine 202 is implemented as part of DTT driver 201. Machine-learning engine 202 can be implemented in hardware and/or software, in accordance with some embodiments.

DTT driver 201 provides DTT telematics data to machine-learning engine 202 and receives in response to that, a prediction activation type. The telematics data include data such as: workload type (e.g., type of application like Microsoft Word®, Microsoft Outlook®, Adobe Reader®, Web browser, etc.), time of invoking the application (e.g., time in the day, day of the week, etc.), current frequency of the processor (e.g., operating clock frequency of the processor executing the workload), current battery charge of a battery powering the processor, operating supply voltage of the processor, current responsiveness of the application being invoked, and current EPP value, etc.).

Machine-learning engine 202 operates based on telemetries and events that are collected by DTT 201 and delivered to ML module 202. ML module 202 in runtime predicts the current type of activities and delivers this prediction value into DTT 201. In some embodiments, machine-learning engine 202 includes a trained model (which may be a trained a priori). In that case, the machine-learning engine 202 applies inference (for prediction type or value) in response to receiving input data. This prediction value can be used by DTT 201 for its control method and is delivered into the HW and pCode via interface between the DTT driver 201 and pCode 103. This interface 203 (e.g., pCode-DTT interface) can be defined as MMIO (memory-mapped IO) registers, MSRs (model-specific registers) or BIOS (basic input/output system) mailbox. Additional data fields are added to interface 203 to communicate the prediction value, type, and/or workload hints from DTT driver 201 to pCode 103. Table 3 provides a functional structure of a 32-bit pCode interface 203.

TABLE 3

| Data Input | Field Name | Description |
|---|---|---|
| DATA[31:31] | DTT pCode setting enable | Set this bet to make the |
| | | current DTT setting into the |
| | | pCode value clear this bit |
| | | causes the pCode to ignore |
| | | the last setting value of |
| | | DTT, default = 0 |
| DATA[30:30] | AC/DC mode | Enable for the pCode the |
| | | current system AC or DC |
| | | mode status, AC=0, DC=1, |
| | | default=AC |
| DATA[29:24] | RESERVED | |
| DATA]23:16] | Thermal constraints | Enable for the pCode the |
| | | current skin temperature |
| | | constraint, 0-100% in units |
| | | of 1/127 (0xFF = fully |
| | | constraint no room for any |
| | | turbo, 0= unconstrained). |
| | | Default=0. |
| DATA[15:8] | Battery status | Enable for the pCode the |
| | | current Battery status. 0- |
| | | 100% in units of 1/127 |
| | | (0xFF=fully constraint no |
| | | room for any Turbo, |
| | | 0=unconstrained). |
| | | Default=0 |
| DATA[7:0] | Workload type | Enable for the pCode the |
| | | current workload type as it |
| | | is identified by the |
| | | machine-learning engine. |
| | | DTT enables the pCode the |
| | | workload classification |
| | | prediction (see below) that |
| | | currently has the maximum |
| | | classification confidence. If |
| | | the confident is low or |
| | | indecisive, DTT |
| | | communicates NA rather |
| | | than the prediction (or some |
| | | consolidation rule) |
| | | 0 - NA |
| | | 1 - IDLE |
| | | 2 - SEMI ACTIVE |
| | | 3 - BURSTY |
| | | 4 - SUSTAINED |
| | | 5 - BATTERY LIFE |

In some embodiments, some or all fields of the 32-bit data input are part of the pCode auxiliary interface. These fields are provided at runtime to pCode control flow 204 which executes the new EPP value by setting a new frequency and/or voltage condition for the processor to enhance user experience. In some embodiments, DTT driver 201 periodically sends a workload hint (e.g., the predicted value) to the SoC (or hardware). For example, DTT sends the workload hint to SoC every 1 second. The period for sending the workload hint is programmable. In some embodiments, DTT may not change the OS EPP setting, but maps the workload hint to an internal HWP algorithm that modifies the HWP behavior similar to changing SoC or Windows OS EPP. In some embodiments, DTT does not send workload hints in AC operating modes (e.g., when the computer is plugged to an AC source instead of a DC battery source). In some embodiments, DTT is not active when the display screen of the computer is off. The various embodiments may not require any changes to the Built-in input/output system (BIOS). The ML algorithm may be pre-trained or for faster EPP adjustment, or can be trained for each computer overtime.

In some embodiments, machine-learning engine 202 is purely software. In some embodiments, machine-learning engine 202 executes on one or more processor core(s) 104, where the machine-learning engine 202 sends the predication value to the same core (that executes the machine-learning engine 202) and controls that same core. In some embodiments, machine-learning engine 202 executes on a dedicated hardware (e.g., application specific integrated circuit) or one of the processor cores, and sends the prediction value to a PCU or some firmware that controls a different core. In some embodiments, machine-learning engine 202 executes in firmware on the same PCU that controls the processor core(s) 104.

The additional modules of FIG. 2 include operating system power management module 205 that provides hardware p-state (HWP) hints to pCode 103 or pCode control flow 204 via pCode OS interface 206. The hardware P-state hints include the static parameters of Table 2, for example. The pCode control flow 204 receives hardware telematics data such as temperature of the processor, current frequency and operating voltage of the processor, number of active processor cores, current C-state of the processor, etc. In some embodiments, this hardware telematics data is combined with the HWP hints from the operating system and provided to machine learning module 202 via the pCode DTT interface 203. Machine-learning module 202 adaptively generates a prediction activation type for DTT driver 201 which dynamically provides an EPP value for pCode 103 or pCode control flow 204 via pCode OS interface 206. In turn, pCode 103 causes the hardware component(s) to adjust frequency and/or voltage to accommodate the new EPP value.

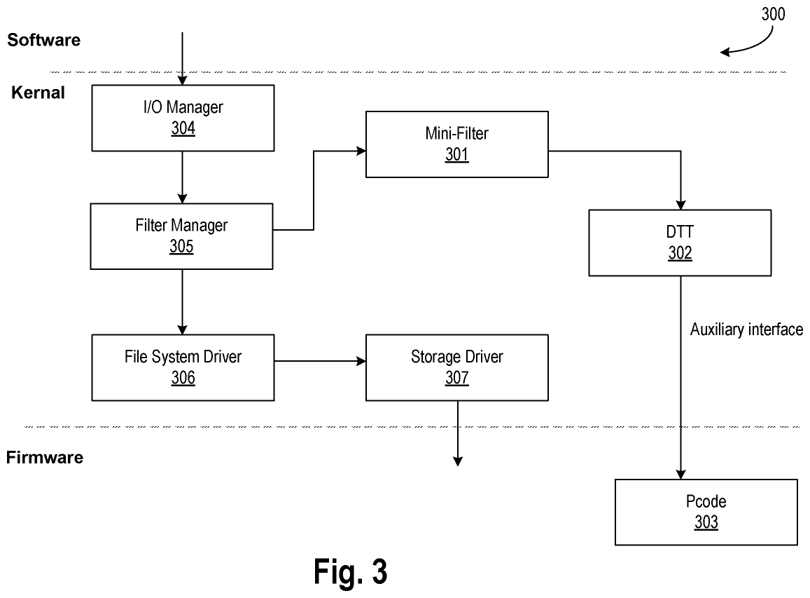

FIG. 3 illustrates architecture 300 using dynamic EPP, in accordance with some embodiments of the disclosure. Architecture 300 is an alternative to architecture flow of FIG. 2. Architecture 300 shows a mini-filter 301, DTT module 302, pCode 303 (same as 103 or control flow 204), I/O manager 304, Filter Manager 305, and File system driver 306. Here, a mini-filter driver 301 is added that identifies when to change the Energy Performance Preference (EPP) value based on workloads and usages. In some embodiments, mini-filter driver 301 registers with filter manager 305 in the existing software architecture and gets notified on certain types of events for the I/O request packets. The I/O requests packets are received by I/O Manager 304. These I/O requests packets are filtered by filter manager 305 which converts the I/O packet requests from one format to another format for the subsequent drivers to handle. For example, filter manager 305 converts the I/O request received by I/O Manager 304 to a format that can be handled by file system driver 306 and/or storage driver 307. The file system driver 306 and/or storage driver 307 then sends the I/O request to the firmware and/or hardware for further processing.

In some embodiments, the algorithm in mini-filter driver 301 processes the events with inputs from the system and determines when to change the EPP. Once it has made the decision, mini-filter driver 301 uses the auxiliary interface via DTT 302 to change the EPP dynamically.

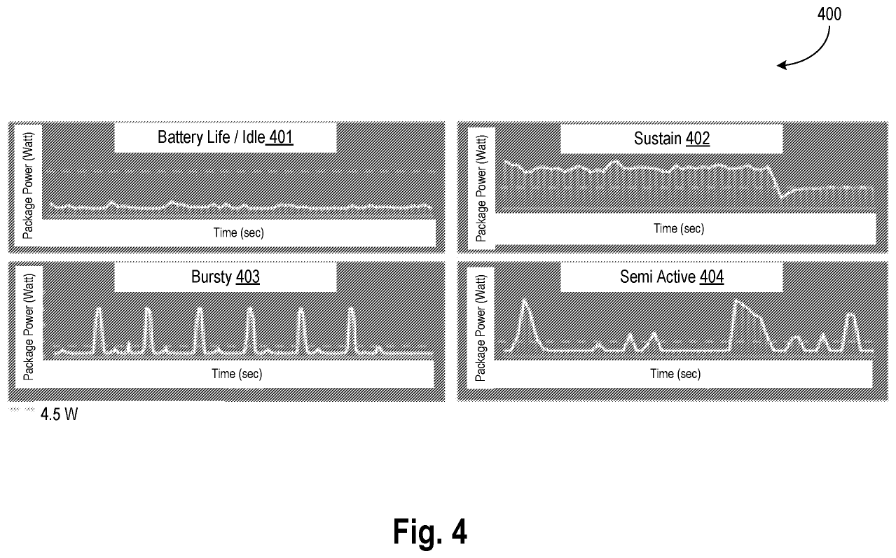

FIG. 4 illustrates a set of plots 400 showing workload classes classified by machine-learning engine 202, in accordance with some embodiments. In computing, a workload (WL) is the amount of processing that the computer has been given to do at a given time. A defined workload can be specified as a benchmark when evaluating a computer system in terms of performance. First step towards predicting workload behavior or hint is defining 5 WL classes—Idle or Battery Life 401, Sustain 402, Bursty 403, and Semi-Active 404.

In idle class, the computer system performs no tasks, power and residency are consistently low for long periods of time. In battery life, power is relatively low, but the processor may still be actively performing a task, such as video playback for a long period of time. Bursty class consumes a relatively constant average amount of power, however, bursts of activity interrupt periods of relative idleness. The bursts are relatively short and spaced with relative idleness which typically do not exhaust PL1 budget for single thread. With multi-threaded workloads, typical the burst power is higher than PL1 but lower than PL2. Semi-Active class consumes a relatively constant average amount of power, significantly below PL1. Relatively long bursts of activity interrupt periods of relative idleness. The bursts may be irregular but long and high enough to exhaust PL2 budget. PL1 (power level 1) is defined as the amount of power the processor is able to consume over a sustained period of time while PL2 (power level 2) indicates the maximum short-term burst power consumption of the chip. In sustain class power level is relatively high for a long period of time as compared to semi-active, with very few to no periods of idleness, which can reach PL2 and PL1 levels.

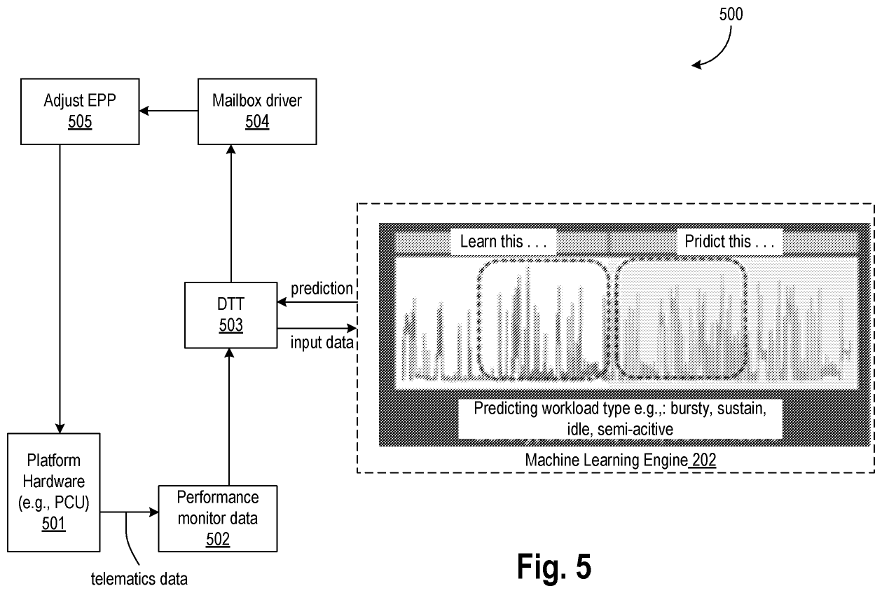

FIG. 5 illustrates flowchart 500 for workload classification, in accordance with some embodiments. While the blocks in flowchart 500 are shown in a particular order, the order can be modified. For example, some blocks may be performed in parallel with other blocks.

At block 501, telematic data (or hardware data) is provided to DTT driver 201 from hardware via pCode interface 203. The hardware (HW) data may be data (e.g., telematics data and input data) from the operation of the processor, but also from components of platform hardware 501 (e.g., power control unit (PCU), processor core(s) 104, graphics processor unit 105, ring interconnect 106, system-on-chip (SoC), etc.). Hardware data may include number of active processor cores, active components, and other telemetry information. At block 502, performance monitoring data is also gathered and provided to DTT driver 201 via pCode interface 203. Performance monitoring data may include power parameters, frequency, residency, temperature and more.

At block 503, DTT driver 201 provides the input data (e.g., telematic data and performance monitoring data) to machine-learning engine 202. In various embodiments, to identify workload characteristics and be able to predict future workload class, a prediction engine 202 (or machine-learning engine 202) is used. Based on the HW data collected, as well as on previous predictions, prediction engine 202 predicts the characteristics of a workload being executed by the processor for a future time period. Prediction engine 202 predicts that the behavior of a future workload to be executed by processor may most likely to be within one of a number of classifications: idle, battery-life, bursty, semi-active or sustained.

Upon receiving the prediction, DTT 503 provides it to mailbox driver 504 (e.g., pCode interface driver) to instruct the pCode to adjust the EPP based on the prediction. At block 505, pCode adjusts the EPP. Thus, upon receiving the workload prediction, DTT 503, in real-time causes adjustment of the EPP based on the prediction from prediction engine 202. For example, if the workload prediction is a bursty classification, then DTT 503 may cause pCode to increase the value of EPP, for instance, to 30%, to improve the system responsiveness. In some embodiments, prediction engine 202 (also referred to machine-learning engine 202) is generic and can fit any platform and pre-trained engine of an original equipment manufacturer (OEM).

Table 4 illustrates the various machine-learning modes based on workload.

TABLE 4

| Machine- | Power saving | |
|---|---|---|
| learning mode | (EPP = = 70%) | Balance (EPP = = 50%) |
| Idle | No impact | Adjust P-Alpha savings, |
| | | decay autonomous response |
| | | (50% [symbol] 70%) |
| Battery Life | No impact | Adjust P-Alpha savings, |
| | | decay autonomous response |
| | | (50% [symbol] 70%) |
| Sustained | No impact | No impact |
| Semi-active | Adjust autonomous | Adjust autonomous |
| | response (70 [symbol] 50%) | response (50% [symbol] 30%) |
| Bursty | Adjust autonomous | Adjust autonomous |
| | response (70 [symbol] 50%) | response (50% [symbol] 30%) |

Depending upon the workload hint and the reference starting EPP value, the pCode algorithm is changed to provide additional burst performance or save energy. As an example, for the bursty workload, the autonomous response is reduced by 20% so that the next result is higher performance.

In some embodiments, pCode uses the workload prediction as an index for the EPP boost tables, which defines the threshold to start or stop boosting from (according to whether the boost is positive or negative), and the boost amount. In some embodiments, there are separate boost tables for the different algorithms that use EPP—Autonomous and P-alpha shown in Table 5, for example.

TABLE 5

| | Autonomous | | P-Alpha | |
|---|---|---|---|---|
| Machine-learning mode | Threshold | Boost | Threshold | Boost |
| Idle | 70% | 20% | 70% | 20% |
| Semi-active | 50% | −20% | 0% | 0% |
| Bursty | 50% | −20% | 0% | 0% |
| Sustained | 0% | 0% | 0% | 0% |
| Battery life | 70% | 20% | 70% | 20% |

The pCode uses two parameters, threshold and boost, in its algorithm to determine the EPP values across the two modes, Autonomous and P-Alpha. By changing the threshold and boost parameters, the performance for bursty workload is increased with higher residencies in higher frequencies of operation.

In some embodiments, EPP may be boosted according to the following: EPP is boosted:
if(boost>0)
   Boosted_EPP=EPP>Threshold? EPP:min(Threshold, EPP+boost)
if(boost<0)
   Boosted_EPP=EPP>Threshold? max(Threshold, EPP-boost):EPP

In some embodiments, autonomous uses the boosted EPP in different parts of the algorithm: Kickdown threshold; Tau for the average C0% window; Delay between changes; C0% thresholds for increasing/decreasing frequency. For P-alpha, boosted EPP is used to calculate alpha, where higher EPP means alpha is more aggressive towards energy saving.

Elements of embodiments are also provided as a machine-readable medium (e.g., memory) for storing the computer-executable instructions (e.g., instructions to implement any other processes discussed herein) also referred to as machine-executable instructions. In some embodiments, the computing platform comprises memory, processor, machine-readable storage media (also referred to as tangible machine readable medium), communication interface (e.g., wireless or wired interface), and network bus coupled together.

In some embodiments, the processor is a Digital Signal Processor (DSP), an Application Specific Integrated Circuit (ASIC), a general-purpose Central Processing Unit (CPU), or a low power logic implementing a simple finite state machine to perform the method of various embodiments, etc.

In some embodiments, the various logic blocks of the system are coupled together via a network bus. Any suitable protocol may be used to implement network bus. In some embodiments, the machine-readable storage medium includes instructions (also referred to as the program software code/instructions) for calculating or measuring distance and relative orientation of a device with reference to another device as described with reference to various embodiments and flowchart.

Program software code/instructions associated with the methods and executed to implement embodiments of the disclosed subject matter may be implemented as part of an operating system or a specific application, component, program, object, module, routine, or other sequence of instructions or organization of sequences of instructions referred to as “program software code/instructions,” “operating system program software code/instructions,” “application program software code/instructions,” or simply “software” or firmware embedded in processor. In some embodiments, the program software code/instructions associated with various embodiments are executed by the computing system.

In some embodiments, the program software code/instructions associated with various flowcharts are stored in a computer executable storage medium and executed by the processor. Here, computer executable storage medium is a tangible machine-readable medium that can be used to store program software code/instructions and data that, when executed by a computing device, causes one or more processors to perform a method(s) as may be recited in one or more accompanying claims directed to the disclosed subject matter.

In some embodiments, the method or operation includes: receiving telematic data and performance data from one or more hardware components; providing the telematic data and performance data to a machine-learning engine to predict a workload type; receiving the predicted workload type; adaptively modifying an energy performance preference based on the predicted workload type; and providing the modified energy performance preference to a firmware which in turn adjusts frequency and/or voltage of the one or more components. In some embodiments, the workload type is one of: idle, semi-active, bursty, sustained, and battery life. In some embodiments, the energy performance preference is visible to an operating system. In some embodiments, the energy performance preference is adjusted to a lower value, performance of the one or more components increases. In some embodiments, as the energy performance preference is adjusted to a higher value, performance increases for the one or more components. In some embodiments, the machine-learning engine is implemented in software and/or hardware. In some embodiments, the one or more components include: one or more processor cores, graphics processing unit, and mesh or ring fabric.

Tangible machine-readable medium may include storage of the executable software program code/instructions and data in various tangible locations, including for example ROM, volatile RAM, non-volatile memory and/or cache and/or other tangible memory as referenced in the present application. Portions of this program software code/instructions and/or data may be stored in any one of these storage and memory devices. Further, the program software code/instructions can be obtained from other storage, including, e.g., through centralized servers or peer-to-peer networks and the like, including the Internet. Different portions of the software program code/instructions and data can be obtained at different times and in different communication sessions or in the same communication session.

The software program code/instructions and data can be obtained in their entirety prior to the execution of a respective software program or application by the computing device. Alternatively, portions of the software program code/instructions and data can be obtained dynamically, e.g., just in time, when needed for execution. Alternatively, some combination of these ways of obtaining the software program code/instructions and data may occur, e.g., for different applications, components, programs, objects, modules, routines or other sequences of instructions or organization of sequences of instructions, by way of example. Thus, it is not required that the data and instructions be on a tangible machine-readable medium in entirety at a particular instance of time.

Examples of tangible computer-readable media include but are not limited to recordable and non-recordable type media such as volatile and non-volatile memory devices, read only memory (ROM), random access memory (RAM), flash memory devices, floppy and other removable disks, magnetic storage media, optical storage media (e.g., Compact Disk Read-Only Memory (CD ROMS), Digital Versatile Disks (DVDs), etc.), among others. The software program code/instructions may be temporarily stored in digital tangible communication links while implementing electrical, optical, acoustical or other forms of propagating signals, such as carrier waves, infrared signals, digital signals, etc. through such tangible communication links.

In general, tangible machine readable medium includes any tangible mechanism that provides (i.e., stores and/or transmits in digital form, e.g., data packets) information in a form accessible by a machine (i.e., a computing device), which may be included, e.g., in a communication device, a computing device, a network device, a personal digital assistant, a manufacturing tool, a mobile communication device, whether or not able to download and run applications and subsidized applications from the communication network, such as the Internet, e.g., an iPhone®, Galaxy®, Blackberry® Droid®, or the like, or any other device including a computing device. In one embodiment, processor-based system is in a form of or included within a PDA (personal digital assistant), a cellular phone, a notebook computer, a tablet, a game console, a set top box, an embedded system, a TV (television), a personal desktop computer, etc. Alternatively, the traditional communication applications and subsidized application(s) may be used in some embodiments of the disclosed subject matter.

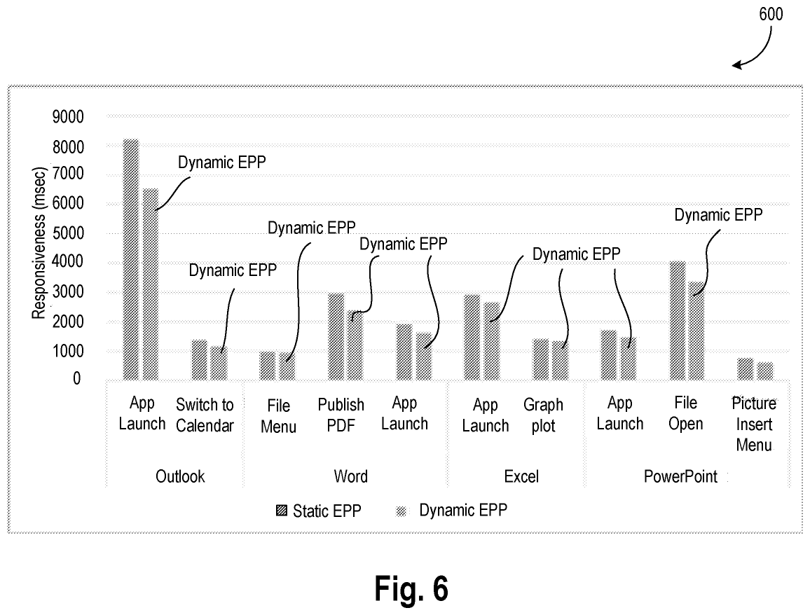

FIG. 6 illustrates plot 600 showing performance gains on direct current (DC) using dynamic EPP, in accordance with some embodiments of the disclosure. Here, the y-axis is the responsiveness of an application in milliseconds. The x-axis includes a list of various applications tested. For each application, responsiveness is determined using the static EPP method and for the dynamic EPP method of various embodiments. The mechanisms and methods disclosed herein improve responsiveness of the applications, for example, by 10% to 20%. As an example, launching an application may improve from 8.1 seconds in the default case (e.g., static EPP) to 6.5 seconds through use of the disclosed mechanisms and methods that use dynamic EPP. The battery life may see a minimal impact of 2% to 3%, since the mechanisms and methods of various embodiments are adaptive, event-based, and configure the EPP dynamically for the duration of the specific type of operations that matter to the user.

FIG. 7 illustrates a computer system or computing device with mechanisms for dynamic EPP, in accordance with some embodiments. It is pointed out that those elements of FIG. 7 having the same reference numbers (or names) as the elements of any other figure may operate or function in any manner similar to that described, but are not limited to such.

In some embodiments, device 2400 represents an appropriate computing device, such as a computing tablet, a mobile phone or smart-phone, a laptop, a desktop, an Internet-of-Things (JOT) device, a server, a wearable device, a set-top box, a wireless-enabled e-reader, or the like. It will be understood that certain components are shown generally, and not all components of such a device are shown in device 2400. Any component of device 2400 can include the latch and/or flip-flop of various embodiments.

In an example, the device 2400 comprises an SoC (System-on-Chip) 2401. An example boundary of the SOC 2401 is illustrated using dotted lines in FIG. 7, with some example components being illustrated to be included within SOC 2401—however, SOC 2401 may include any appropriate components of device 2400.

In some embodiments, device 2400 includes processor 2404. Processor 2404 can include one or more physical devices, such as microprocessors, application processors, microcontrollers, programmable logic devices, processing cores, or other processing means. The processing operations performed by processor 2404 include the execution of an operating platform or operating system on which applications and/or device functions are executed. The processing operations include operations related to I/O (input/output) with a human user or with other devices, operations related to power management, operations related to connecting computing device 2400 to another device, and/or the like. The processing operations may also include operations related to audio I/O and/or display I/O.

In some embodiments, processor 2404 includes multiple processing cores (also referred to as cores) 2408a, 2408b, 2408c. Although merely three cores 2408a, 2408b, 2408c are illustrated in FIG. 7, processor 2404 may include any other appropriate number of processing cores, e.g., tens, or even hundreds of processing cores. Processor cores 2408a, 2408b, 2408c may be implemented on a single integrated circuit (IC) chip. Moreover, the chip may include one or more shared and/or private caches, buses or interconnections, graphics and/or memory controllers, or other components.

In some embodiments, processor 2404 includes cache 2406. In an example, sections of cache 2406 may be dedicated to individual cores 2408 (e.g., a first section of cache 2406 dedicated to core 2408a, a second section of cache 2406 dedicated to core 2408b, and so on). In an example, one or more sections of cache 2406 may be shared among two or more of cores 2408. Cache 2406 may be split in different levels, e.g., level 1 (L1) cache, level 2 (L2) cache, level 3 (L3) cache, etc.

In some embodiments, processor core 2404 may include a fetch unit to fetch instructions (including instructions with conditional branches) for execution by the core 2404. The instructions may be fetched from any storage devices such as the memory 2430. Processor core 2404 may also include a decode unit to decode the fetched instruction. For example, the decode unit may decode the fetched instruction into a plurality of micro-operations. Processor core 2404 may include a schedule unit to perform various operations associated with storing decoded instructions. For example, the schedule unit may hold data from the decode unit until the instructions are ready for dispatch, e.g., until all source values of a decoded instruction become available. In one embodiment, the schedule unit may schedule and/or issue (or dispatch) decoded instructions to an execution unit for execution.

The execution unit may execute the dispatched instructions after they are decoded (e.g., by the decode unit) and dispatched (e.g., by the schedule unit). In an embodiment, the execution unit may include more than one execution unit (such as an imaging computational unit, a graphics computational unit, a general-purpose computational unit, etc.). The execution unit may also perform various arithmetic operations such as addition, subtraction, multiplication, and/or division, and may include one or more an arithmetic logic units (ALUs). In an embodiment, a co-processor (not shown) may perform various arithmetic operations in conjunction with the execution unit.

Further, execution unit may execute instructions out-of-order. Hence, processor core 2404 may be an out-of-order processor core in one embodiment. Processor core 2404 may also include a retirement unit. The retirement unit may retire executed instructions after they are committed. In an embodiment, retirement of the executed instructions may result in processor state being committed from the execution of the instructions, physical registers used by the instructions being de-allocated, etc. Processor core 2404 may also include a bus unit to enable communication between components of processor core 2404 and other components via one or more buses. Processor core 2404 may also include one or more registers to store data accessed by various components of the core 2404 (such as values related to assigned app priorities and/or sub-system states (modes) association.

In some embodiments, device 2400 comprises connectivity circuitries 2431. For example, connectivity circuitries 2431 includes hardware devices (e.g., wireless and/or wired connectors and communication hardware) and/or software components (e.g., drivers, protocol stacks), e.g., to enable device 2400 to communicate with external devices. Device 2400 may be separate from the external devices, such as other computing devices, wireless access points or base stations, etc.

In an example, connectivity circuitries 2431 may include multiple different types of connectivity. To generalize, the connectivity circuitries 2431 may include cellular connectivity circuitries, wireless connectivity circuitries, etc. Cellular connectivity circuitries of connectivity circuitries 2431 refers generally to cellular network connectivity provided by wireless carriers, such as provided via GSM (global system for mobile communications) or variations or derivatives, CDMA (code division multiple access) or variations or derivatives, TDM (time division multiplexing) or variations or derivatives, 3rd Generation Partnership Project (3GPP) Universal Mobile Telecommunications Systems (UMTS) system or variations or derivatives, 3GPP Long-Term Evolution (LTE) system or variations or derivatives, 3GPP LTE-Advanced (LTE-A) system or variations or derivatives, Fifth Generation (5G) wireless system or variations or derivatives, 5G mobile networks system or variations or derivatives, 5G New Radio (NR) system or variations or derivatives, or other cellular service standards. Wireless connectivity circuitries (or wireless interface) of the connectivity circuitries 2431 refers to wireless connectivity that is not cellular, and can include personal area networks (such as Bluetooth, Near Field, etc.), local area networks (such as Wi-Fi), and/or wide area networks (such as WiMax), and/or other wireless communication. In an example, connectivity circuitries 2431 may include a network interface, such as a wired or wireless interface, e.g., so that a system embodiment may be incorporated into a wireless device, for example, a cell phone or personal digital assistant.

In some embodiments, device 2400 comprises control hub 2432, which represents hardware devices and/or software components related to interaction with one or more I/O devices. For example, processor 2404 may communicate with one or more of display 2422, one or more peripheral devices 2424, storage devices 2428, one or more other external devices 2429, etc., via control hub 2432. Control hub 2432 may be a chipset, a Platform Control Hub (PCH), and/or the like.

For example, control hub 2432 illustrates one or more connection points for additional devices that connect to device 2400, e.g., through which a user might interact with the system. For example, devices (e.g., devices 2429) that can be attached to device 2400 include microphone devices, speaker or stereo systems, audio devices, video systems or other display devices, keyboard or keypad devices, or other I/O devices for use with specific applications such as card readers or other devices.

As mentioned above, control hub 2432 can interact with audio devices, display 2422, etc. For example, input through a microphone or other audio device can provide input or commands for one or more applications or functions of device 2400. Additionally, audio output can be provided instead of, or in addition to display output. In another example, if display 2422 includes a touch screen, display 2422 also acts as an input device, which can be at least partially managed by control hub 2432. There can also be additional buttons or switches on computing device 2400 to provide I/O functions managed by control hub 2432. In one embodiment, control hub 2432 manages devices such as accelerometers, cameras, light sensors or other environmental sensors, or other hardware that can be included in device 2400. The input can be part of direct user interaction, as well as providing environmental input to the system to influence its operations (such as filtering for noise, adjusting displays for brightness detection, applying a flash for a camera, or other features).

In some embodiments, control hub 2432 may couple to various devices using any appropriate communication protocol, e.g., PCIe (Peripheral Component Interconnect Express), USB (Universal Serial Bus), Thunderbolt, High Definition Multimedia Interface (HDMI), Firewire, etc.

In some embodiments, display 2422 represents hardware (e.g., display devices) and software (e.g., drivers) components that provide a visual and/or tactile display for a user to interact with device 2400. Display 2422 may include a display interface, a display screen, and/or hardware device used to provide a display to a user. In some embodiments, display 2422 includes a touch screen (or touch pad) device that provides both output and input to a user. In an example, display 2422 may communicate directly with the processor 2404. Display 2422 can be one or more of an internal display device, as in a mobile electronic device or a laptop device or an external display device attached via a display interface (e.g., DisplayPort, etc.). In one embodiment display 2422 can be a head mounted display (HMD) such as a stereoscopic display device for use in virtual reality (VR) applications or augmented reality (AR) applications.

In some embodiments, and although not illustrated in the figure, in addition to (or instead of) processor 2404, device 2400 may include Graphics Processing Unit (GPU) comprising one or more graphics processing cores, which may control one or more aspects of displaying contents on display 2422.

Control hub 2432 (or platform controller hub) may include hardware interfaces and connectors, as well as software components (e.g., drivers, protocol stacks) to make peripheral connections, e.g., to peripheral devices 2424.

It will be understood that device 2400 could both be a peripheral device to other computing devices, as well as have peripheral devices connected to it. Device 2400 may have a “docking” connector to connect to other computing devices for purposes such as managing (e.g., downloading and/or uploading, changing, synchronizing) content on device 2400. Additionally, a docking connector can allow device 2400 to connect to certain peripherals that allow computing device 2400 to control content output, for example, to audiovisual or other systems.

In addition to a proprietary docking connector or other proprietary connection hardware, device 2400 can make peripheral connections via common or standards-based connectors. Common types can include a Universal Serial Bus (USB) connector (which can include any of a number of different hardware interfaces), DisplayPort including MiniDisplayPort (MDP), High Definition Multimedia Interface (HDMI), Firewire, or other types.

In some embodiments, connectivity circuitries 2431 may be coupled to control hub 2432, e.g., in addition to, or instead of, being coupled directly to the processor 2404. In some embodiments, display 2422 may be coupled to control hub 2432, e.g., in addition to, or instead of, being coupled directly to processor 2404.

In some embodiments, device 2400 comprises memory 2430 coupled to processor 2404 via memory interface 2434. Memory 2430 includes memory devices for storing information in device 2400.

In some embodiments, memory 2430 includes apparatus to maintain stable clocking as described with reference to various embodiments. Memory can include nonvolatile (state does not change if power to the memory device is interrupted) and/or volatile (state is indeterminate if power to the memory device is interrupted) memory devices. Memory device 2430 can be a dynamic random access memory (DRAM) device, a static random access memory (SRAM) device, flash memory device, phase-change memory device, or some other memory device having suitable performance to serve as process memory. In one embodiment, memory 2430 can operate as system memory for device 2400, to store data and instructions for use when the one or more processors 2404 executes an application or process. Memory 2430 can store application data, user data, music, photos, documents, or other data, as well as system data (whether long-term or temporary) related to the execution of the applications and functions of device 2400.

Elements of various embodiments and examples are also provided as a machine-readable medium (e.g., memory 2430) for storing the computer-executable instructions (e.g., instructions to implement any other processes discussed herein). The machine-readable medium (e.g., memory 2430) may include, but is not limited to, flash memory, optical disks, CD-ROMs, DVD ROMs, RAMs, EPROMs, EEPROMs, magnetic or optical cards, phase change memory (PCM), or other types of machine-readable media suitable for storing electronic or computer-executable instructions. For example, embodiments of the disclosure may be downloaded as a computer program (e.g., BIOS) which may be transferred from a remote computer (e.g., a server) to a requesting computer (e.g., a client) by way of data signals via a communication link (e.g., a modem or network connection).

In some embodiments, device 2400 comprises temperature measurement circuitries 2440, e.g., for measuring temperature of various components of device 2400. In an example, temperature measurement circuitries 2440 may be embedded, or coupled or attached to various components, whose temperature are to be measured and monitored. For example, temperature measurement circuitries 2440 may measure temperature of (or within) one or more of cores 2408a, 2408b, 2408c, voltage regulator 2414, memory 2430, a mother-board of SOC 2401, and/or any appropriate component of device 2400.

In some embodiments, device 2400 comprises power measurement circuitries 2442, e.g., for measuring power consumed by one or more components of the device 2400. In an example, in addition to, or instead of, measuring power, the power measurement circuitries 2442 may measure voltage and/or current. In an example, the power measurement circuitries 2442 may be embedded, or coupled or attached to various components, whose power, voltage, and/or current consumption are to be measured and monitored. For example, power measurement circuitries 2442 may measure power, current and/or voltage supplied by one or more voltage regulators 2414, power supplied to SOC 2401, power supplied to device 2400, power consumed by processor 2404 (or any other component) of device 2400, etc.

In some embodiments, device 2400 comprises one or more voltage regulator circuitries, generally referred to as voltage regulator (VR) 2414. VR 2414 generates signals at appropriate voltage levels, which may be supplied to operate any appropriate components of the device 2400. Merely as an example, VR 2414 is illustrated to be supplying signals to processor 2404 of device 2400. In some embodiments, VR 2414 receives one or more Voltage Identification (VID) signals, and generates the voltage signal at an appropriate level, based on the VID signals. Various type of VRs may be utilized for the VR 2414. For example, VR 2414 may include a “buck” VR, “boost” VR, a combination of buck and boost VRs, low dropout (LDO) regulators, switching DC-DC regulators, constant-on-time controller-based DC-DC regulator, etc. Buck VR is generally used in power delivery applications in which an input voltage needs to be transformed to an output voltage in a ratio that is smaller than unity. Boost VR is generally used in power delivery applications in which an input voltage needs to be transformed to an output voltage in a ratio that is larger than unity. In some embodiments, each processor core has its own VR, which is controlled by PCU 2410a/b and/or PMIC 2412. In some embodiments, each core has a network of distributed LDOs to provide efficient control for power management. The LDOs can be digital, analog, or a combination of digital or analog LDOs. In some embodiments, VR 2414 includes current tracking apparatus to measure current through power supply rail(s).

In some embodiments, device 2400 comprises one or more clock generator circuitries, generally referred to as clock generator 2416. Clock generator 2416 generates clock signals at appropriate frequency levels, which may be supplied to any appropriate components of device 2400. Merely as an example, clock generator 2416 is illustrated to be supplying clock signals to processor 2404 of device 2400. In some embodiments, clock generator 2416 receives one or more Frequency Identification (FID) signals, and generates the clock signals at an appropriate frequency, based on the FID signals.

In some embodiments, device 2400 comprises battery 2418 supplying power to various components of device 2400. Merely as an example, battery 2418 is illustrated to be supplying power to processor 2404. Although not illustrated in the figures, device 2400 may comprise a charging circuitry, e.g., to recharge the battery, based on Alternating Current (AC) power supply received from an AC adapter.

In some embodiments, device 2400 comprises Power Control Unit (PCU) 2410 (also referred to as Power Management Unit (PMU), Power Controller, etc.). In an example, some sections of PCU 2410 may be implemented by one or more processing cores 2408, and these sections of PCU 2410 are symbolically illustrated using a dotted box and labelled PCU 2410a. In an example, some other sections of PCU 2410 may be implemented outside the processing cores 2408, and these sections of PCU 2410 are symbolically illustrated using a dotted box and labelled as PCU 2410b. PCU 2410 may implement various power management operations for device 2400. PCU 2410 may include hardware interfaces, hardware circuitries, connectors, registers, etc., as well as software components (e.g., drivers, protocol stacks), to implement various power management operations for device 2400.

In some embodiments, device 2400 comprises Power Management Integrated Circuit (PMIC) 2412, e.g., to implement various power management operations for device 2400. In some embodiments, PMIC 2412 is a Reconfigurable Power Management ICs (RPMICs) and/or an IMVP (Intel® Mobile Voltage Positioning). In an example, the PMIC is within an IC chip separate from processor 2404. The may implement various power management operations for device 2400. PMIC 2412 may include hardware interfaces, hardware circuitries, connectors, registers, etc., as well as software components (e.g., drivers, protocol stacks), to implement various power management operations for device 2400.

In an example, device 2400 comprises one or both PCU 2410 or PMIC 2412. In an example, any one of PCU 2410 or PMIC 2412 may be absent in device 2400, and hence, these components are illustrated using dotted lines.

Various power management operations of device 2400 may be performed by PCU 2410, by PMIC 2412, or by a combination of PCU 2410 and PMIC 2412. For example, PCU 2410 and/or PMIC 2412 may select a power state (e.g., P-state) for various components of device 2400. For example, PCU 2410 and/or PMIC 2412 may select a power state (e.g., in accordance with the ACPI (Advanced Configuration and Power Interface) specification) for various components of device 2400. Merely as an example, PCU 2410 and/or PMIC 2412 may cause various components of the device 2400 to transition to a sleep state, to an active state, to an appropriate C state (e.g., C0 state, or another appropriate C state, in accordance with the ACPI specification), etc. In an example, PCU 2410 and/or PMIC 2412 may control a voltage output by VR 2414 and/or a frequency of a clock signal output by the clock generator, e.g., by outputting the VID signal and/or the FID signal, respectively. In an example, PCU 2410 and/or PMIC 2412 may control battery power usage, charging of battery 2418, and features related to power saving operation.

The clock generator 2416 can comprise a phase locked loop (PLL), frequency locked loop (FLL), or any suitable clock source. In some embodiments, each core of processor 2404 has its own clock source. As such, each core can operate at a frequency independent of the frequency of operation of the other core. In some embodiments, PCU 2410 and/or PMIC 2412 performs adaptive or dynamic frequency scaling or adjustment. For example, clock frequency of a processor core can be increased if the core is not operating at its maximum power consumption threshold or limit. In some embodiments, PCU 2410 and/or PMIC 2412 determines the operating condition of each core of a processor, and opportunistically adjusts frequency and/or power supply voltage of that core without the core clocking source (e.g., PLL of that core) losing lock when the PCU 2410 and/or PMIC 2412 determines that the core is operating below a target performance level. For example, if a core is drawing current from a power supply rail less than a total current allocated for that core or processor 2404, then PCU 2410 and/or PMIC 2412 can temporality increase the power draw for that core or processor 2404 (e.g., by increasing clock frequency and/or power supply voltage level) so that the core or processor 2404 can perform at higher performance level. As such, voltage and/or frequency can be increased temporality for processor 2404 without violating product reliability.

In an example, PCU 2410 and/or PMIC 2412 may perform power management operations, e.g., based at least in part on receiving measurements from power measurement circuitries 2442, temperature measurement circuitries 2440, charge level of battery 2418, and/or any other appropriate information that may be used for power management. To that end, PMIC 2412 is communicatively coupled to one or more sensors to sense/detect various values/variations in one or more factors having an effect on power/thermal behavior of the system/platform. Examples of the one or more factors include electrical current, voltage droop, temperature, operating frequency, operating voltage, power consumption, inter-core communication activity, etc. One or more of these sensors may be provided in physical proximity (and/or thermal contact/coupling) with one or more components or logic/IP blocks of a computing system. Additionally, sensor(s) may be directly coupled to PCU 2410 and/or PMIC 2412 in at least one embodiment to allow PCU 2410 and/or PMIC 2412 to manage processor core energy at least in part based on value(s) detected by one or more of the sensors.

Also illustrated is an example software stack of device 2400 (although not all elements of the software stack are illustrated). Merely as an example, processors 2404 may execute application programs 2450, Operating System (OS) 2452, one or more Power Management (PM) specific application programs (e.g., generically referred to as PM applications 2458), and/or the like. PM applications 2458 may also be executed by the PCU 2410 and/or PMIC 2412. OS 2452 may also include one or more PM applications 2456a, 2456b, 2456c. The OS 2452 may also include various drivers 2454a, 2454b, 2454c, etc., some of which may be specific for power management purposes. In some embodiments, device 2400 may further comprise a Basic Input/Output System (BIOS) 2420. BIOS 2420 may communicate with OS 2452 (e.g., via one or more drivers 2454), communicate with processors 2404, etc.

For example, one or more of PM applications 2458, 2456, drivers 2454, BIOS 2420, etc. may be used to implement power management specific tasks, e.g., to control voltage and/or frequency of various components of device 2400, to control wake-up state, sleep state, and/or any other appropriate power state of various components of device 2400, control battery power usage, charging of the battery 2418, features related to power saving operation, etc.

In some embodiments, pCode executing on PCU 2410a/b has a capability to enable extra compute and telemetries resources for the runtime support of the pCode. Here, pCode refers to a firmware executed by PCU 2410a/b to manage performance of the 2401. For example, pCode may set frequencies and appropriate voltages for the processor. Part of the pCode are accessible via OS 2452. In various embodiments, mechanisms and methods are provided that dynamically change an Energy Performance Preference (EPP) value based on workloads, user behavior, and/or system conditions. There may be a well-defined interface between OS 2452 and the pCode. The interface may allow or facilitate the software configuration of several parameters and/or may provide hints to the pCode. As an example, an EPP parameter may inform a pCode algorithm as to whether performance or battery life is more important.

This support may be done as well by the OS 2452 by including machine-learning support as part of OS 2452 and either tuning the EPP value that the OS hints to the hardware (e.g., various components of SCO 2401) by machine-learning prediction, or by delivering the machine-learning prediction to the pCode in a manner similar to that done by a Dynamic Tuning Technology (DTT) driver. In this model, OS 2452 may have visibility to the same set of telemetries as are available to a DTT. As a result of a DTT machine-learning hint setting, pCode may tune its internal algorithms to achieve optimal power and performance results following the machine-learning prediction of activation type. The pCode as example may increase the responsibility for the processor utilization change to enable fast response for user activity, or may increase the bias for energy saving either by reducing the responsibility for the processor utilization or by saving more power and increasing the performance lost by tuning the energy saving optimization. This approach may facilitate saving more battery life in case the types of activities enabled lose some performance level over what the system can enable. The pCode may include an algorithm for dynamic EPP that may take the two inputs, one from OS 2452 and the other from software such as DTT, and may selectively choose to provide higher performance and/or responsiveness. As part of this method, the pCode may enable in the DTT an option to tune its reaction for the DTT for different types of activity.

Reference in the specification to “an embodiment,” “one embodiment,” “some embodiments,” or “other embodiments” means that a particular feature, structure, or characteristic described in connection with the embodiments is included in at least some embodiments, but not necessarily all embodiments. The various appearances of “an embodiment,” “one embodiment,” or “some embodiments” are not necessarily all referring to the same embodiments. If the specification states a component, feature, structure, or characteristic “may,” “might,” or “could” be included, that particular component, feature, structure, or characteristic is not required to be included. If the specification or claim refers to “a” or “an” element, that does not mean there is only one of the elements. If the specification or claims refer to “an additional” element, that does not preclude there being more than one of the additional elements.

Furthermore, the particular features, structures, functions, or characteristics may be combined in any suitable manner in one or more embodiments. For example, a first embodiment may be combined with a second embodiment anywhere the particular features, structures, functions, or characteristics associated with the two embodiments are not mutually exclusive.

While the disclosure has been described in conjunction with specific embodiments thereof, many alternatives, modifications and variations of such embodiments will be apparent to those of ordinary skill in the art in light of the foregoing description. For example, other memory architectures e.g., Dynamic RAM (DRAM) may use the embodiments discussed. The embodiments of the disclosure are intended to embrace all such alternatives, modifications, and variations as to fall within the broad scope of the appended claims.

In addition, well known power/ground connections to integrated circuit (IC) chips and other components may or may not be shown within the presented figures, for simplicity of illustration and discussion, and so as not to obscure the disclosure. Further, arrangements may be shown in block diagram form in order to avoid obscuring the disclosure, and also in view of the fact that specifics with respect to implementation of such block diagram arrangements are highly dependent upon the platform within which the present disclosure is to be implemented (i.e., such specifics should be well within purview of one skilled in the art). Where specific details (e.g., circuits) are set forth in order to describe example embodiments of the disclosure, it should be apparent to one skilled in the art that the disclosure can be practiced without, or with variation of, these specific details. The description is thus to be regarded as illustrative instead of limiting.

The following examples pertain to further embodiments. Specifics in the examples may be used anywhere in one or more embodiments. All optional features of the apparatus described herein may also be implemented with respect to a method or process.

Various embodiments described herein are illustrated as examples. The features of these examples can be combined with one another in any suitable way. These examples include:

Example 1: An apparatus comprising: one or more hardware components; and a firmware to execute on at least one of the one or more hardware components, wherein the firmware adaptively adjusts an energy performance preference for the one or more hardware components based on parameters including predicted workload and usage behavior of applications executed on the one or more hardware components.

Example 2: The apparatus of example 1 comprises a machine-learning engine to predict a workload type based on telematic data from the one or more hardware components.

Example 3: The apparatus of example 2, wherein the workload type is one of: idle, semi-active, bursty, sustained, and battery life.

Example 4: The apparatus of example 2, wherein the machine-learning engine has a pre-trained model to predict the workload.

Example 5: The apparatus of example 2, wherein the machine-learning engine is implemented in hardware and/or software.

Example 6: The apparatus of example 1, wherein the energy performance preference is visible to an operating system.

Example 7: The apparatus of example 1, wherein the firmware adjusts frequency and/or voltage of the one or more hardware components according to the adaptively adjusted energy performance preference.

Example 8: The apparatus of example 1, wherein as the energy performance preference is adjusted to a lower value, performance increases for the one or more components, or wherein as the energy performance preference is adjusted to a higher value, energy reduces for the one or more components.

Example 9: The apparatus according to any one of examples 1 to 8, wherein the one or more components include: one or more processor cores, graphics processing unit, and mesh or ring fabric.

Example 10: A machine-readable storage media having machine-executable instructions, that when executed, cause one or more machines to perform an operating comprising: receiving telematic data and performance data from one or more hardware components; providing the telematic data and performance data to a machine-learning engine to predict a workload type; receiving the predicted workload type; adaptively modifying an energy performance preference based on the predicted workload type; and providing the modified energy performance preference to a firmware which in turn adjusts frequency and/or voltage of the one or more components.

Example 11: The machine-readable storage media of example 10, wherein the workload type is one of: idle, semi-active, bursty, sustained, and battery life.

Example 12: The machine-readable storage media of example 10, the energy performance preference is visible to an operating system.

Example 13: The machine-readable storage media of example 10, wherein the energy performance preference is adjusted to a lower value, performance increases for the one or more components, or wherein as the energy performance preference is adjusted to a higher value, energy reduces for the one or more components.

Example 14: The machine-readable storage media of example 10, wherein the machine-learning engine is implemented in software and/or hardware.

Example 15: The machine-readable storage media according to any one of examples 10 to 14, wherein the one or more components include: one or more processor cores, graphics processing unit, and mesh or ring fabric.

Example 16: A system comprising: a memory; a processor coupled to the memory; a wireless interface communicatively coupled to the processor, wherein the processor includes a power control unit which executes a firmware that adaptively adjusts an energy performance preference for one or more hardware components of the system, including the processor, based on parameters including predicted workload and usage behavior of applications executed on the one or more hardware components; and a machine-learning engine communicatively coupled to the firmware, wherein the machine-learning engine predicts a workload type based on telematic data from the one or more hardware components.

Example 17: The system of example 16, wherein the workload type is one of: idle, semi-active, bursty, sustained, and battery life.

Example 18: The system of example 16, wherein the machine-learning engine has a pre-trained model to predict the workload.

Example 19: The system of example 18, wherein the firmware adjusts frequency and/or voltage of the one or more hardware components according to the adaptively adjusted energy performance preference.

Example 20: The system according to any one of examples 16 to 19, wherein as the energy performance preference is adjusted to a lower value, performance increases for the one or more components or wherein as the energy performance preference is adjusted to a higher value, performance increases for the one or more components.

Example 21: A method comprising: receiving telematic data and performance data from one or more hardware components; providing the telematic data and performance data to a machine-learning engine to predict a workload type; receiving the predicted workload type; adaptively modifying an energy performance preference based on the predicted workload type; and providing the modified energy performance preference to a firmware which in turn adjusts frequency and/or voltage of the one or more components.

Example 22: The method of example 21, wherein the workload type is one of: idle, semi-active, bursty, sustained, and battery life.

Example 23: The method of claim 21, the energy performance preference is visible to an operating system.

Example 24: The method of example 21, wherein the energy performance preference is adjusted to a lower value, performance increases for the one or more components, or wherein as the energy performance preference is adjusted to a higher value, energy reduces for the one or more components.

Example 25: The method of example 21, wherein the machine-learning engine is implemented in software and/or hardware.

Example 26: The method according to any one of examples 21 to 25, wherein the one or more components include: one or more processor cores, graphics processing unit, and mesh or ring fabric.

An abstract is provided that will allow the reader to ascertain the nature and gist of the technical disclosure. The abstract is submitted with the understanding that it will not be used to limit the scope or meaning of the claims. The following claims are hereby incorporated into the detailed description, with each claim standing on its own as a separate embodiment.

1-26. (canceled)

27. An apparatus comprising:
one or more hardware components; and
a firmware to execute on at least one of the one or more hardware components, wherein the firmware adaptively adjusts an energy performance preference for the one or more hardware components based on parameters including predicted workload and usage behavior of applications executed on the one or more hardware components.

28. The apparatus of claim 27, further comprising a machine-learning engine to predict a workload type based on telematic data from the one or more hardware components.

29. The apparatus of claim 28, wherein the workload type is one of: idle, semi-active, bursty, sustained, and battery life.

30. The apparatus of claim 28, wherein the machine-learning engine has a pre-trained model to predict the workload.

31. The apparatus of claim 28, wherein the machine-learning engine is implemented in hardware and/or software.

32. The apparatus of claim 27, wherein the energy performance preference is visible to an operating system.

33. The apparatus of claim 27, wherein the firmware adjusts frequency and/or voltage of the one or more hardware components according to the adaptively adjusted energy performance preference.

34. The apparatus of claim 27, wherein as the energy performance preference is adjusted to a lower value, performance increases for the one or more components, or wherein as the energy performance preference is adjusted to a higher value, energy reduces for the one or more components.

35. The apparatus of claim 27, wherein the one or more components include: one or more processor cores, a graphics processing unit, and a mesh or ring fabric.

36. A machine-readable storage media having machine-executable instructions, that when executed, cause one or more machines to perform operations comprising:
receiving telematic data and performance data from one or more hardware components;
providing the telematic data and performance data to a machine-learning engine to predict a workload type;
receiving the predicted workload type;
adaptively modifying an energy performance preference based on the predicted workload type; and
providing the modified energy performance preference to a firmware which in turn adjusts frequency and/or voltage of the one or more components.

37. The machine-readable storage media of claim 36, wherein the workload type is one of: idle, semi-active, bursty, sustained, and battery life.

38. The machine-readable storage media of claim 36, the energy performance preference is visible to an operating system.

39. The machine-readable storage media of claim 36, wherein the energy performance preference is adjusted to a lower value, performance increases for the one or more components, or wherein as the energy performance preference is adjusted to a higher value, energy reduces for the one or more components.

40. The machine-readable storage media of claim 36, wherein the machine-learning engine is implemented in software and/or hardware.

41. The machine-readable storage media of claim 36, wherein the one or more components include: one or more processor cores, a graphics processing unit, and a mesh or ring fabric.

42. A system comprising:
a memory;
a processor coupled to the memory;
a wireless interface communicatively coupled to the processor, wherein the processor includes a power control unit which executes a firmware that adaptively adjusts an energy performance preference for one or more hardware components of the system, including the processor, based on parameters including predicted workload and usage behavior of applications executed on the one or more hardware components; and
a machine-learning engine communicatively coupled to the firmware, wherein the machine-learning engine predicts a workload type based on telematic data from the one or more hardware components.

43. The system of claim 42, wherein the workload type is one of: idle, semi-active, bursty, sustained, and battery life.

44. The system of claim 42, wherein the machine-learning engine has a pre-trained model to predict the workload.

45. The system of claim 44, wherein the firmware adjusts frequency and/or voltage of the one or more hardware components according to the adaptively adjusted energy performance preference.

46. The system of claim 42, wherein as the energy performance preference is adjusted to a lower value, performance increases for the one or more components or wherein as the energy performance preference is adjusted to a higher value, performance increases for the one or more components.

47. A method comprising:
receiving telematic data and performance data from one or more hardware components;
providing the telematic data and performance data to a machine-learning engine to predict a workload type;
receiving the predicted workload type;
adaptively modifying an energy performance preference based on the predicted workload type; and
providing the modified energy performance preference to a firmware which in turn adjusts frequency and/or voltage of the one or more components.

48. The method of claim 47, wherein the workload type is one of: idle, semi-active, bursty, sustained, and battery life.

49. The method of claim 47, wherein the energy performance preference is visible to an operating system.

50. The method of claim 47, wherein the energy performance preference is adjusted to a lower value, performance increases for the one or more components, or wherein as the energy performance preference is adjusted to a higher value, energy reduces for the one or more components.

51. The method of claim 47, wherein the one or more components include: one or more processor cores, a graphics processing unit, and a mesh or ring fabric.
